(19) United States
(12) Patent Application Publication
(10) Pub. No.: US 2026/0112305 A1
(43) Pub. Date: Apr. 23, 2026

(54) PIXEL, DISPLAY DEVICE INCLUDING THE PIXEL, AND ELECTRONIC APPARATUS INCLUDING THE DISPLAY DEVICE

(71) Applicant: Samsung Display Co., LTD., Yongin-si (KR)

(72) Inventors: YEONKYUNG KIM, Yongin-si (KR); KYUNG-BAE KIM, Yongin-si (KR); DONGWOO KIM, Yongin-si (KR); YONGHEE LEE, Yongin-si (KR)

(21) Appl. No.: 19/250,733

(22) Filed: Jun. 26, 2025

(30) Foreign Application Priority Data
Oct. 21, 2024 (KR) 10-2024-0143610

(51) Int. Cl. G09G 3/32; G09G 3/3233

(52) U.S. Cl. CPC G09G 3/32; G09G 3/3233; G09G 2300/0819

(57) ABSTRACT

A pixel includes a light-emitting element including an anode and a cathode which receives a low power voltage, a first transistor including a gate connected a first node, a first terminal connected to a second node, and a second terminal connected to a third node, a second transistor which transmits a data voltage to the first node in response to a first gate signal, a third transistor including a gate connected to the second node, a first terminal which receives a high power voltage, and a second terminal connected to the second node, and a fifth transistor including a gate which receives an emission signal, a first terminal connected to the third node, and a second terminal connected to the anode of the light-emitting element. An activation level of the emission signal is higher than an activation level of the first gate signal.

This application claims priority to Korean Patent Application No. 10-2024-0143610 filed on Oct. 21, 2024, and all the benefits accruing therefrom under 35 U.S.C. § 119, the content of which in its entirety is herein incorporated by reference.

### BACKGROUND

### 1. Field

Embodiments relate to a display device. More particularly, embodiments relate to a pixel including a plurality of transistors, a display device including the pixel, and an electronic apparatus including the display device.

### 2. Description of the Related Art

A display device may include a display panel and a panel driver. The display panel may include a plurality of pixels. The panel driver may provide data voltages, gate signals, etc. to the pixels.

The pixel may include a light-emitting element and a plurality of transistors. The transistors may generate a driving current based on the data voltage, the gate signal, etc. The light-emitting element may emit light with a luminance corresponding to the driving current.

### SUMMARY

Recently, a demand for a high-resolution display device has been increasing. In order to increase a resolution of the display device, an area of the pixel may be desired to be reduced. However, if the number of transistors included in the pixel maintains, the reduction in the area of the pixel may be limited, and accordingly, the increase in the resolution of the display device may also be limited.

Embodiments provide a pixel with reduced area.

Embodiments provide a display device with increased resolution and an electronic apparatus including the display device.

A pixel according to embodiments includes a light-emitting element including an anode and a cathode which receives a low power voltage, a first transistor including a gate connected a first node, a first terminal connected to a second node, and a second terminal connected to a third node, a second transistor which transmits a data voltage to the first node in response to a first gate signal, a third transistor including a gate connected to the second node, a first terminal which receives a high power voltage, and a second terminal connected to the second node, and a fifth transistor including a gate which receives an emission signal, a first terminal connected to the third node, and a second terminal connected to the anode of the light-emitting element. In such embodiments, an activation level of the emission signal is higher than an activation level of the first gate signal.

In an embodiment, the pixel may further include a fourth transistor which transmits an initialization voltage to the anode of the light-emitting element in response to a second gate signal.

In an embodiment, an activation level of the second gate signal may be lower than the activation level of the first gate signal.

In an embodiment, a voltage level of the initialization voltage may be lower than a voltage level of the low power voltage.

In an embodiment, in an initialization and writing period of a frame, each of the first gate signal and the second gate signal may have the activation level, and the emission signal may have a deactivation level.

In an embodiment, in an emission period of the frame after the initialization and writing period, the emission signal may have the activation level, and each of the first gate signal and the second gate signal may have a deactivation level.

In an embodiment, the fifth transistor may operate in a saturation region in the emission period.

In an embodiment, a voltage level of the data voltage may be variable, and a length of the emission period may be constant.

In an embodiment, a voltage level of the data voltage may be constant, and a length of the emission period may be variable.

In an embodiment, each of the first transistor, the second transistor, the third transistor, the fourth transistor, and the fifth transistor may be a p-type metal oxide semiconductor (PMOS) transistor.

In an embodiment, a body of each of the first transistor, the second transistor, the third transistor, the fourth transistor, and the fifth transistor may receive the high power voltage.

In an embodiment, the pixel may further include a first capacitor including a first terminal connected to the first node and a second terminal which receives the high power voltage.

A display device according to embodiments includes a display panel including a pixel, and a panel driver which provides a data voltage, a first gate signal, and an emission signal to the pixel. In such embodiments, the pixel includes a light-emitting element including an anode and a cathode which receives a low power voltage, a first transistor including a gate connected a first node, a first terminal connected to a second node, and a second terminal connected to a third node, a second transistor which transmits the data voltage to the first node in response to the first gate signal, a third transistor including a gate connected to the second node, a first terminal which receives a high power voltage, and a second terminal connected to the second node, and a fifth transistor including a gate which receives the emission signal, a first terminal connected to the third node, and a second terminal connected to the anode of the light-emitting element. In such embodiments, an activation level of the emission signal is higher than an activation level of the first gate signal.

In an embodiment, the pixel may further include a fourth transistor which transmits an initialization voltage to the anode of the light-emitting element in response to a second gate signal.

In an embodiment, an activation level of the second gate signal may be lower than the activation level of the first gate signal.

In an embodiment, a voltage level of the initialization voltage may be lower than a voltage level of the low power voltage.

In an embodiment, in an initialization and writing period of a frame, each of the first gate signal and the second gate signal may have the activation level, and the emission signal may have a deactivation level.

In an embodiment, in an emission period of the frame after the initialization and writing period, the emission signal may have the activation level, and each of the first gate signal and the second gate signal may have a deactivation level.

In an embodiment, the fifth transistor may operate in a saturation region in the emission period.

An electronic apparatus according to embodiments includes a processor which generates image data, and a display device which displays an image corresponding to the image data. In such embodiments, the display device includes a display panel including a pixel, and a panel driver which provides a data voltage, a first gate signal, and an emission signal to the pixel. In such embodiments, the pixel includes a light-emitting element including an anode and a cathode which receives a low power voltage, a first transistor including a gate connected a first node, a first terminal connected to a second node, and a second terminal connected to a third node, a second transistor which transmits the data voltage to the first node in response to the first gate signal, a third transistor including a gate connected to the second node, a first terminal which receives a high power voltage, and a second terminal connected to the second node, and a fifth transistor including a gate which receives the emission signal, a first terminal connected to the third node, and a second terminal connected to the anode of the light-emitting element. In such embodiments, an activation level of the emission signal is higher than an activation level of the first gate signal.

In the pixel, the display device, and the electronic apparatus according to embodiments of the disclosure, the number of the transistors included in the pixel decreases, so that an area of the pixel may be reduced, and a resolution of the display device may increase. In such embodiments, a data swing range may increase by the third transistor of the pixel, and a degradation of the light-emitting element, a deviation in threshold voltage of the first transistor, and a deviation in mobility of the first transistor may be compensated. In such embodiments, a characteristic of a driving current flowing through the light-emitting element may be improved by the fifth transistor of the pixel.

### BRIEF DESCRIPTION OF THE DRAWINGS

Illustrative, non-limiting embodiments will be more clearly understood from the following detailed description taken in conjunction with the accompanying drawings.

FIG. 1 is a block diagram illustrating a display device according to an embodiment.

FIG. 2 is a circuit diagram illustrating a pixel of FIG. 1.

FIG. 3 is a waveform diagram illustrating an example of a first gate signal, a second gate signal, and an emission signal of FIG. 2.

FIG. 4 is a diagram for describing an operation of the pixel of FIG. 2 in an initialization and writing period.

FIG. 5 is a diagram for describing an operation of the pixel of FIG. 2 in an emission period.

FIG. 6 is a graph for describing a voltage-current characteristic of a first transistor of FIG. 2.

FIG. 7 is a graph for describing a characteristic of a driving current flowing through a light-emitting element of FIG. 2.

FIG. 8 is a waveform diagram illustrating an example of the first gate signal, the second gate signal, and the emission signal of FIG. 2.

FIG. 9 is a block diagram illustrating an electronic apparatus according to an embodiment.

FIG. 10 is a diagram illustrating an example in which the electronic apparatus of FIG. 9 is implemented as a head mounted display (HMD).

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, a pixel, a display device, and an electronic apparatus according to embodiments of the present disclosure will be described in greater detail with reference to the accompanying drawings. The same or similar reference numerals will be used for the same elements in the accompanying drawings.

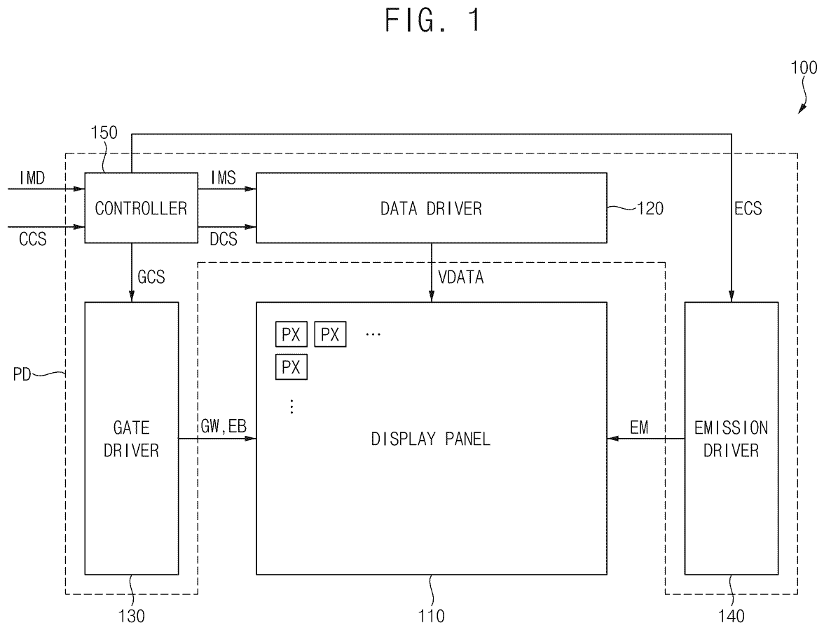

FIG. 1 is a block diagram illustrating a display device 100 according to an embodiment.

Referring to FIG. 1, an embodiment of the display device 100 may include a display panel 110 and a panel driver PD.

The display panel 110 may include a plurality of pixels PX. Each of the pixels PX may emit light based on a data voltage VDATA, a first gate signal GW, a second gate signal EB, and an emission signal EM.

The panel driver PD may provide the data voltage VDATA, the first gate signal GW, the second gate signal EB, and the emission signal EM to each of the pixels PX. The panel driver PD may include a data driver 120, a gate driver 130, an emission driver 140, and a controller 150.

The data driver 120 may provide data voltages VDATA to the pixels PX. The data driver 120 may generate the data voltages VDATA based on an image signal IMS and a data control signal DCS. The image signal IMS may include grayscale values corresponding to the pixels PX. The data control signal DCS may include a load signal, a data clock signal, etc.

The gate driver 130 may provide first gate signals GW and second gate signals EB to the pixels PX. The gate driver 130 may generate the first gate signals GW and the second gate signals EB based on a gate control signal GCS. The gate control signal GCS may include a first gate start signal, a second gate start signal, a first gate clock signal, a second gate clock signal, etc.

The emission driver 140 may provide emission signals EM to the pixels PX. The emission driver 140 may generate the emission signals EM based on an emission control signal ECS. The emission control signal ECS may include an emission start signal, an emission clock signal, etc.

The controller 150 may control an operation of the data driver 120, an operation of the gate driver 130, and an operation of the emission driver 140. The controller 150 may provide the image signal IMS and the data control signal DCS to the data driver 120, may provide the gate control signal GCS to the gate driver 130, and may provide the emission control signal ECS to the emission driver 140. The controller 150 may generate the image signal IMS based on image data IMD, and may generate the data control signal DCS, the gate control signal GCS, and the emission control signal ECS based on a controller control signal CCS. The image data IMD may include grayscale values corresponding to pixels PX. The controller control signal CCS may include a data enable signal, a vertical synchronization signal, a horizontal synchronization signal, a master clock signal, etc.

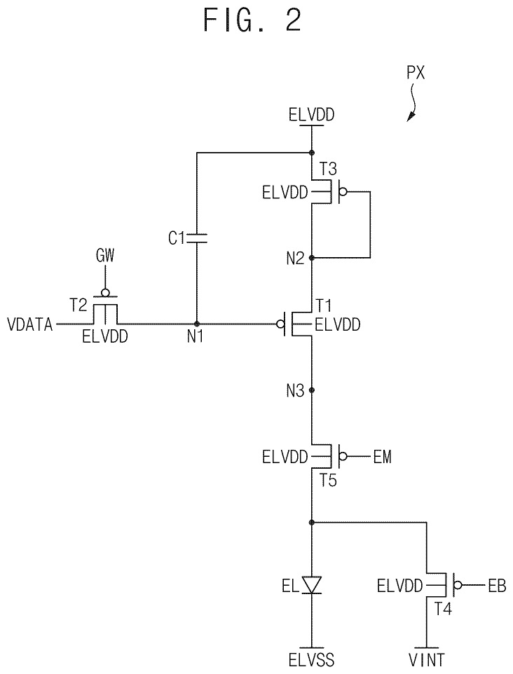

FIG. 2 is a circuit diagram illustrating the pixel PX of FIG. 1.

Referring to FIGS. 1 and 2, in an embodiment, the pixel PX may receive the data voltage VDATA, the first gate signal GW, the second gate signal EB, the emission signal EM, an initialization voltage VINT, a high power voltage ELVDD, and a low power voltage ELVSS. In an embodiment, a voltage level of the high power voltage ELVDD may be higher than a voltage level of the low power voltage ELVSS. In an embodiment, a voltage level of the initialization voltage VINT may be lower than the voltage level of the low power voltage ELVSS.

In an embodiment, as shown in FIG. 2, the pixel PX may include a light-emitting element EL, a first transistor T1, a second transistor T2, a third transistor T3, a fourth transistor T4, a fifth transistor T5, and a first capacitor C1.

The light-emitting element EL may include an anode and a cathode that receives the low power voltage ELVSS. The light-emitting element EL may emit light with a luminance corresponding to a driving current.

In an embodiment, the light-emitting element EL may be an organic light-emitting diode. In another embodiment, the light-emitting element EL may be an inorganic light-emitting diode, a quantum dot light-emitting diode, or a micro light-emitting diode, for example.

The first transistor T1 may include a gate connected to a first node N1, a first terminal (e.g., a source) connected to a second node N2, and a second terminal (e.g., a drain) connected to a third node N3. The first transistor T1 may generate the driving current.

The second transistor T2 may transmit the data voltage VDATA to the first node N1 in response to the first gate signal GW. The second transistor T2 may include a gate that receives the first gate signal GW, a first terminal (e.g., a source) that receives the data voltage VDATA, and a second terminal (e.g., a drain) connected to the first node N1.

The third transistor T3 may include a gate connected to the second node N2, a first terminal (e.g., a source) that receives the high power voltage ELVDD, and a second terminal (e.g., a drain) connected to the second node N2. Since the gate of the third transistor T3 is connected to the second terminal of the third transistor T3, the third transistor T3 may be diode-connected, i.e., connected in a diode form.

The fourth transistor T4 may transmit the initialization voltage VINT to the anode of the light-emitting element EL in response to the second gate signal EB. The fourth transistor T4 may include a gate that receives the second gate signal EB, a first terminal (e.g., a source) that receives the initialization voltage VINT, and a second terminal (e.g., a drain) connected to the anode of the light-emitting element EL.

The fifth transistor T5 may include a gate that receives the emission signal EM, a first terminal (e.g., a source) connected to the third node N3, and a second terminal (e.g., a drain) connected to the anode of the light-emitting element EL. The fifth transistor T5 may form a current path of the driving current from a line that transmits the high power voltage ELVDD to a line that transmits the low power voltage ELVSS in response to the emission signal EM.

In an embodiment, each of the first transistor T1, the second transistor T2, the third transistor T3, the fourth transistor T4, and the fifth transistor T5 may be a p-channel metal oxide semiconductor (PMOS) transistor. In an embodiment, each of the first transistor T1, the second transistor T2, the third transistor T3, the fourth transistor T4, and the fifth transistor T5 may be a polycrystalline silicon transistor.

In an embodiment, each of the first transistor T1, the second transistor T2, the third transistor T3, the fourth transistor T4, and the fifth transistor T5 may further include a body. In such an embodiment, the body may be defined by a semiconductor region of each of the first transistor T1, the second transistor T2, the third transistor T3, the fourth transistor T4, and the fifth transistor T5. In an embodiment, the body of each of the first transistor T1, the second transistor T2, the third transistor T3, the fourth transistor T4, and the fifth transistor T5 may receive the high power voltage ELVDD.

The first capacitor C1 may include a first terminal connected to the first node N1 and a second terminal that receives the high power voltage ELVDD. The first capacitor C1 may store a voltage of the first node N1.

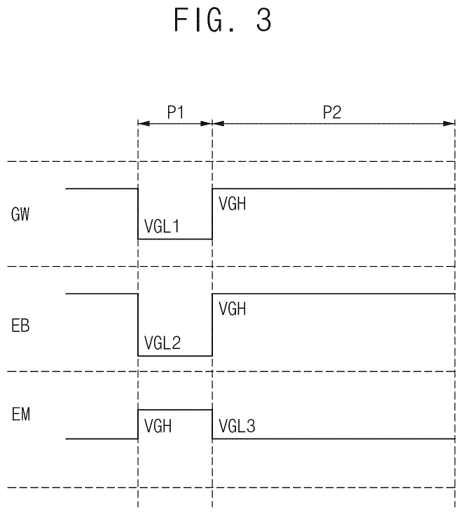

FIG. 3 is a waveform diagram illustrating an example of the first gate signal GW, the second gate signal EB, and the emission signal EM of FIG. 2.

Referring to FIGS. 2 and 3, in an embodiment, the first gate signal GW may have an activation level (e.g., a first low gate voltage) VGL1 in an initialization and writing period P1 of a frame, and a deactivation level (e.g., a high gate voltage) VGH in an emission period P2 of the frame.

The second gate signal EB may have an activation level (e.g., a second low gate voltage) VGL2 in the initialization and writing period P1, and a deactivation level (e.g., the high gate voltage) VGH in the emission period P2. The activation level VGL2 of the second gate signal EB may be lower than the activation level VGL1 of the first gate signal GW.

The emission signal EM may have a deactivation level (e.g., the high gate voltage) VGH in the initialization and writing period P1, and may have an activation level (e.g., a third low gate voltage) VGL3 in the emission period P2. The activation level VGL3 of the emission signal EM may be higher than the activation level VGL1 of the first gate signal GW.

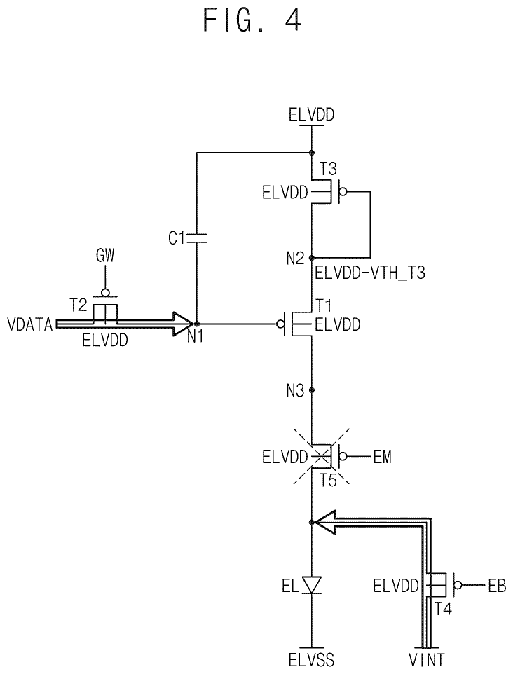

FIG. 4 is a diagram for describing an operation of the pixel PX of FIG. 2 in the initialization and writing period P1.

Referring to FIGS. 3 and 4, in the initialization and writing period P1, the second transistor T2 may be turned on in response to the first gate signal GW having the activation level VGL1, and the data voltage VDATA may be applied to the first node N1 through the second transistor T2. The data voltage VDATA may be stored in the first node N1 by the first capacitor C1.

In the initialization and writing period P1, a value obtained by subtracting the threshold voltage VTH_T3 of the third transistor T3 from the high power voltage ELVDD may be applied to the second node N2.

In the initialization and writing period P1, the fourth transistor T4 may be turned on in response to the second gate signal EB having the activation level VGL2, and the initialization voltage VINT may be applied to the anode of the light-emitting element EL through the fourth transistor T4. Accordingly, charge stored in the anode of the light-emitting element EL may be discharged to a line that transmits the initialization voltage VINT through the fourth transistor T4, and the light-emitting element EL may be initialized.

In such an embodiment, a voltage level of the initialization voltage VINT applied to the first terminal of the fourth transistor T4 may be lower than a minimum voltage level of the data voltage VDATA applied to the first terminal of the second transistor T2. Accordingly, the activation level VGL2 of the second gate signal EB applied to the gate of the fourth transistor T4 may be lower than the activation level VGL1 of the first gate signal GW applied to the gate of the second transistor T2 such that the fourth transistor T4 may smoothly transmit the initialization voltage VINT to the anode of the light-emitting element EL in response to the second gate signal EB.

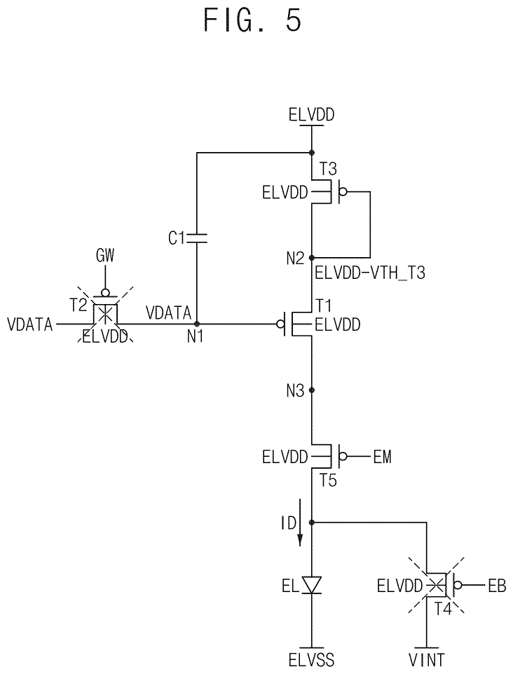

FIG. 5 is a diagram for describing an operation of the pixel PX of FIG. 2 in the emission period P2.

Referring to FIGS. 3 and 5, in the emission period P2, the fifth transistor T5 may be turned on in response to the emission signal EM having the activation level VGL3, a current path may be formed through the third transistor T3, the first transistor T1, the fifth transistor T5, and the light-emitting element EL from a line that transmits the high power voltage ELVDD to a line that transmits the low power voltage ELVSS, the first transistor T1 may generate the driving current ID, and the light-emitting element EL may emit light with a luminance corresponding to an amplitude of the driving current ID and a width of the driving current ID.

In an embodiment, the pixel PX may express a grayscale by a pulse amplitude modulation (PAM) method that controls the amplitude of the driving current ID. The amplitude of the driving current ID may correspond to a voltage level of the data voltage VDATA, and the width of the driving current ID may correspond to a length of the emission period P2. When the pixel PX expresses the grayscale in the PAM method, the voltage level of the data voltage VDATA may be variable, and the length of the emission period P2 may be constant. Accordingly, the pixel PX may express the grayscale by controlling the voltage level of the data voltage VDATA corresponding to the amplitude of the driving current ID.

In the emission period P2, the fifth transistor T5 may operate in a saturation region. In order for the fifth transistor T5 to operate in the saturation region, the activation level VGL3 of the emission signal EM applied to the gate of the fifth transistor T5 may be higher than the activation level VGL1 of the first gate signal GW applied to the gate of the second transistor T2.

A pixel of the prior art may include seven or more transistors for generating the driving current ID, and thus, the reduction of the area of the pixel may be limited. In an embodiment, as described above, the pixel PX includes only five transistors, such that the area of the pixel PX may be reduced, and thus, the resolution of the display device 100 may increase.

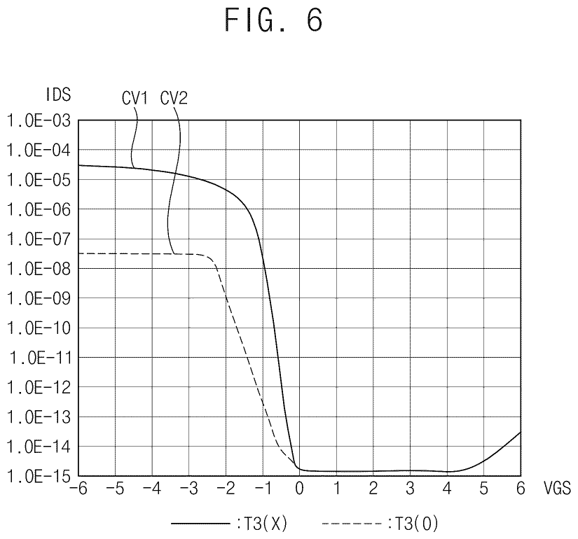

FIG. 6 is a graph for describing a voltage-current characteristic of the first transistor T1 of FIG. 2.

In the graph of FIG. 6, an X-axis represents a voltage (e.g., gate-source voltage) VGS between the gate and the first terminal of the first transistor T1, and a Y-axis represents a current (e.g., drain-source current) IDS flowing through the first transistor T1. In FIG. 6, a first curve CV1 represents a relationship between the gate-source voltage VGS and the drain-source current IDS of the first transistor T1 when the pixel PX does not include the third transistor T3, and a second curve CV2 represents a relationship between the gate-source voltage VGS and the drain-source current IDS of the first transistor T1 when the pixel PX includes the third transistor T3.

Referring to FIG. 6, in a region where the gate-source voltage VGS of the first transistor T1 is less than about zero (0) volt (V), a magnitude of a slope of the second curve CV2 may be less than a magnitude of a slope of the first curve CV1. Accordingly, when the pixel PX includes the third transistor T3, a data swing range, which represents a difference between a minimum voltage level and a maximum voltage level of the data voltage VDATA, may be greater than a data swing range when the pixel PX does not include the third transistor T3. In other words, as the pixel PX includes the third transistor T3, the data swing range may increase.

In an embodiment, as the pixel PX includes the third transistor T3, a deviation of a threshold voltage (VTH_T1) of the first transistor T1 may be compensated. When the threshold voltage (VTH_T1) of the first transistor T1 increases, the amplitude of the driving current ID may decrease according to Equation 1.

ID=K×(VSG−VTH_T1)² [Equation 1]

In Equation 1, VSG denotes a voltage between the first terminal and the gate of the first transistor T1 (e.g., source-gate voltage), VTH_T1 denotes a threshold voltage of the first transistor T1, and K denotes a proportional constant. When the amplitude of the driving current ID decreases, a voltage of the second node N2 may increase by the diode-connected third transistor T3, and accordingly, the source-gate voltage VSG of the first transistor T1 may increase. When the source-gate voltage VSG of the first transistor T1 increases, the amplitude of the driving current ID may increase according to Equation 1. In other words, although the threshold voltage VTH_T1 of the first transistor T1 increases, the amplitude of the driving current ID may not decrease because the third transistor T3 serves as a feedback.

In an embodiment, as the pixel PX includes the third transistor T3, a deviation of mobility of the first transistor T1 may be compensated. When the mobility of the first transistor T1 increases, the amplitude of the driving current ID may increase. When the amplitude of the driving current ID increases, the voltage of the second node N2 may decrease by the diode-connected third transistor T3, and accordingly, the source-gate voltage VSG of the first transistor T1 may decrease. When the source-gate voltage VSG of the first transistor T1 decreases, the amplitude of the driving current ID may decrease according to Equation 1. In other words, although the mobility of the first transistor T1 increases, the amplitude of the driving current ID may not increase because the third transistor T3 serves as a feedback.

In an embodiment, as the pixel PX includes the third transistor T3, a degradation of the light-emitting element EL may be compensated. When the light-emitting element EL is degraded, a voltage of the anode of the light-emitting element EL may increase, and thus, a voltage of the gate of the first transistor T1 may increase. When the voltage of the gate of the first transistor T1 increases, the source-gate voltage VSG of the first transistor T1 may decrease. When the source-gate voltage VSG of the first transistor T1 decreases, the amplitude of the driving current ID may decrease according to Equation 1. When the amplitude of the driving current ID decreases, the voltage of the second node N2 may increase by the diode-connected third transistor T3, and thus, the source-gate voltage VSG of the first transistor T1 may increase. When the source-gate voltage VSG of the first transistor T1 increases, the amplitude of the driving current ID may increase according to Equation 1. In other words, although the light-emitting element EL is degraded, the amplitude of the driving current ID may not decrease because the third transistor T3 serves as a feedback.

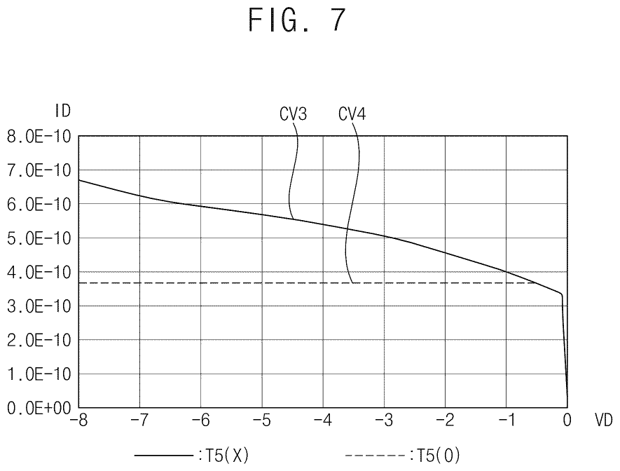

FIG. 7 is a graph for describing a characteristic of the driving current ID flowing through the light-emitting element EL of FIG. 2.

In FIG. 7, an X-axis represents a voltage (e.g., drain voltage) VD of the second terminal of the first transistor T1, and a Y-axis represents the driving current ID flowing through the light-emitting element EL. In FIG. 7, a third curve CV3 represents a relationship between the drain voltage VD and the driving current ID of the first transistor T1 when the pixel PX does not include the fifth transistor T5, and a fourth curve CV4 represents a relationship between the drain voltage VD and the driving current ID of the first transistor T1 when the pixel PX includes the fifth transistor T5.

Referring to FIG. 7, in a region where the drain voltage VD of the first transistor T1 is less than about −0.5 V, an absolute value of a slope of the third curve CV3 may be greater than zero (0), and a slope of the fourth curve CV4 may be about zero (0). Accordingly, the amplitude of the driving current ID may vary depending on the drain voltage VD of the first transistor T1 when the pixel PX does not include the fifth transistor T5, however, the amplitude of the driving current ID may be constant regardless of the drain voltage VD of the first transistor T1 when the pixel PX includes the fifth transistor T5. When the fifth transistor T5 operates in the saturation region, the fifth transistor T5 may function as an active load, and the characteristic of the driving current ID (for example, a luminance long range uniformity (LRU)) and a degradation of the light-emitting element EL may be improved.

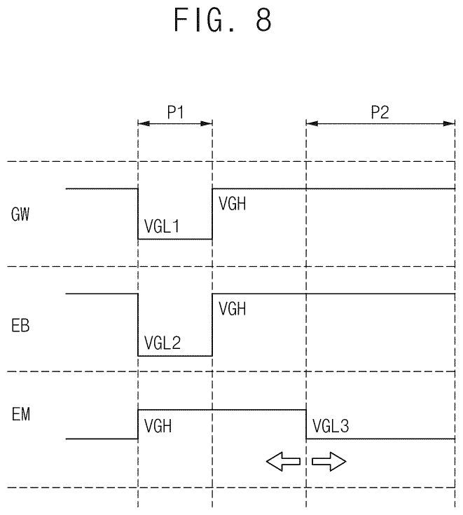

FIG. 8 is a waveform diagram illustrating an example of the first gate signal GW, the second gate signal EB, and the emission signal EM of FIG. 2.

Detailed descriptions of the operation of the pixel PX by the signals shown FIG. 8, which are substantially the same as or similar to those of the operation of the pixel PX described above with reference to FIGS. 3 to 5, will be omitted.

Referring to FIGS. 2 and 8, in an embodiment, the pixel PX may express a grayscale by a pulse width modulation (PWM) method that controls the width of the driving current ID. When the pixel PX expresses the grayscale by the PWM method, the voltage level of the data voltage VDATA may be constant, and the length of the emission period P2 may be variable. Accordingly, the pixel PX may express the grayscale by controlling the length of the emission period P2 corresponding to the width of the driving current ID.

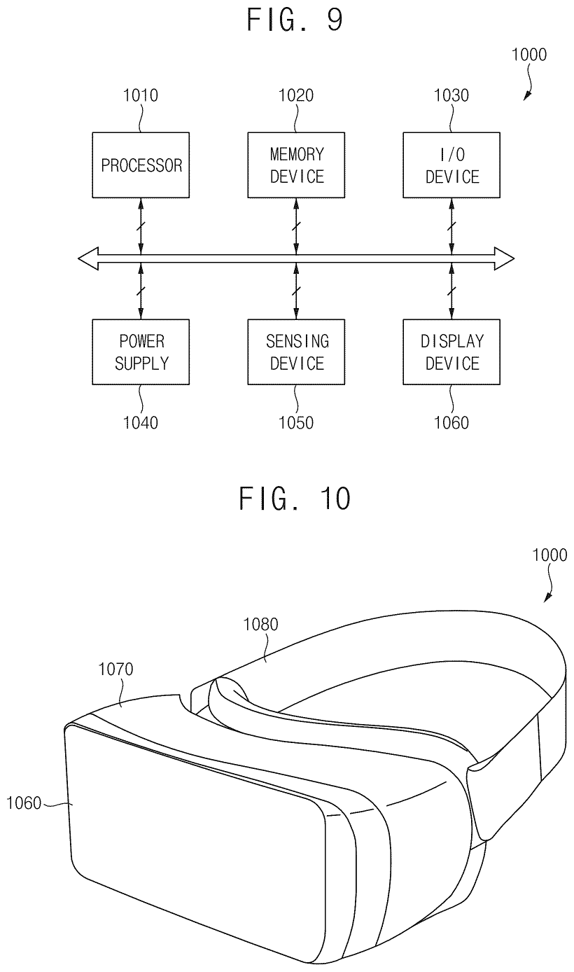

FIG. 9 is a block diagram illustrating an electronic apparatus 1000 according to an embodiment.

Referring to FIG. 9, an embodiment of the electronic apparatus 1000 may include a processor 1010, a memory device 1020, an input/output (I/O) device 1030, a power supply 1040, a sensing device 1050, and a display device 1060. Components of the electronic apparatus 1000 are not limited to the components illustrated in FIG. 9, and the electronic apparatus 1000 may have more or fewer components than the components illustrated in FIG. 9.

The processor 1010 may perform specific calculations or tasks. The processor 1010 may control an overall operation of the electronic apparatus 1000. In an embodiment, the processor 1010 may be a microprocessor, a central processing unit (CPU), or the like. The processor 1010 may be connected to other components through an address bus, a control bus, a data bus, or the like. In an embodiment, the processor 1010 may also be connected to an expansion bus such as a peripheral component interconnect (PCI) bus.

The memory device 1020 may store data used for an operation of the electronic apparatus 1000. In an embodiment, for example, the memory device 1020 may include: a nonvolatile memory device such as an erasable programmable read-only memory (EPROM), an electrically erasable programmable read-only memory (EEPROM), a flash memory, a phase change random access memory (PRAM), a resistance random access memory (RRAM), a nano floating gate memory (NFGM), a polymer random access memory (PoRAM), a magnetic random access memory (MRAM), or a ferroelectric random access memory (FRAM); and/or a volatile memory device such as a dynamic random access memory (DRAM), a static random access memory (SRAM), or a mobile DRAM.

The I/O device 1030 may include: an input device including a camera or an image inputter configured to input an image signal, a microphone or an audio inputter configured to input an audio signal, a user inputter (e.g., a touch key, a push key, a joystick, a wheel, etc.) configured to receive information from a user, or the like; and an output device including an audio outputter, a haptic module, an optical outputter, and the like configured to generate an output associated with visual sensation, auditory sensation, tactile sensation, or the like.

The power supply 1040 may supply a power used for the operation of the electronic apparatus 1000. The power supply 1040 may receive an external power and an internal power, and may supply the power to each of the components included in the electronic apparatus 1000. The power supply 1040 may be implemented as a built-in battery or a replaceable battery.

The sensing device 1050 may include at least one sensor configured to sense information on a peripheral environment of the electronic apparatus 1000, information on a user of the electronic apparatus 1000, or the like. In an embodiment, for example, the sensing device 1050 may include a speed sensor, an acceleration sensor, a gravity sensor, an illumination sensor, a motion sensor, a fingerprint recognition sensor, an optical sensor, an ultrasonic sensor, a heat sensor, or the like.

The display device 1060 may be connected to other components through the buses or other communication links. The display device 1060 may display information processed by the electronic apparatus 1000. The display device 1060 may correspond to the display device 100 of FIG. 1.

FIG. 10 is a diagram illustrating an example in which the electronic apparatus 1000 of FIG. 9 is implemented as a head mounted display (HMD).

Referring to FIG. 10, an embodiment of the electronic apparatus 1000 may include the display device 1060, a housing 1070, and a mounting part 1080. The electronic apparatus 1000 may be mounted on a head of a user to provide image information to the user. The display device 1060 may display an image based on image data. The display device 1060 may provide the image to each of left and right eyes of the user. A left eye image corresponding to the left eye of the user and a right eye image corresponding to the right eye of the user may be identical to or different from each other. The electronic apparatus 1000 may provide a two-dimensional image, a three-dimensional image, virtual reality (VR), augmented reality (AR), a 360-degree panoramic image, or the like through the display device 1060.

The display device 1060 may be a liquid crystal display device, an organic light emitting display device, an inorganic light emitting display device, a quantum dot light emitting display device, or the like. The display device 1060 may be mounted in the housing 1070, or may be coupled to the housing 1070. The display device 1060 may receive an instruction through an interface unit or the like provided in the housing 1070.

The housing 1070 may be located on a front side of the eyes of the user. The housing 1070 may store the components configured to operate the electronic apparatus 1000. In addition, a wireless communication unit, the interface unit, and the like may be located in the housing 1070. The wireless communication unit may perform wireless communication with an external terminal and receive an image signal from the external terminal. In an embodiment, for example, the wireless communication unit may communicate with the external terminal by using Bluetooth, radio frequency identification (RFID), infrared data association (IrDA), ZigBee, near field communication (NFC), wireless-fidelity (Wi-Fi), ultra-wideband (UWB), or the like. The interface unit may connect the electronic apparatus 1000 to an external device. In an embodiment, for example, the interface unit may include at least one of a wired/wireless headset port, an external charger port, a wired/wireless data port, a memory card port, a port configured to connect a device provided with an identification module, an audio I/O port, a video I/O port, and an earphone port.

The mounting part 1080 may be connected to the housing 1070 to fix the electronic apparatus 1000 to the head of the user. In an embodiment, for example, the mounting part 1080 may be implemented as a belt, a band having elasticity, or the like.

The display device according to embodiments may be applied to a display device included in various electronic devices such as a computer, a notebook, a mobile phone, a smart phone, a smart pad, a smart watch, a portable media player (PMP), a personal digital assistant (PDA), an MP3 player, or the like.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. A pixel comprising:
a light-emitting element including an anode and a cathode which receives a low power voltage;
a first transistor including a gate connected a first node, a first terminal connected to a second node, and a second terminal connected to a third node;
a second transistor which transmits a data voltage to the first node in response to a first gate signal;
a third transistor including a gate connected to the second node, a first terminal which receives a high power voltage, and a second terminal connected to the second node; and
a fifth transistor including a gate which receives an emission signal, a first terminal connected to the third node, and a second terminal connected to the anode of the light-emitting element,
wherein an activation level of the emission signal is higher than an activation level of the first gate signal.

2. The pixel of claim 1, further comprising:
a fourth transistor which transmits an initialization voltage to the anode of the light-emitting element in response to a second gate signal.

3. The pixel of claim 2, wherein an activation level of the second gate signal is lower than the activation level of the first gate signal.

4. The pixel of claim 3, wherein a voltage level of the initialization voltage is lower than a voltage level of the low power voltage.

5. The pixel of claim 2, wherein, in an initialization and writing period of a frame, each of the first gate signal and the second gate signal has the activation level, and the emission signal has a deactivation level.

6. The pixel of claim 5, wherein, in an emission period of the frame after the initialization and writing period, the emission signal has the activation level, and each of the first gate signal and the second gate signal has a deactivation level.

7. The pixel of claim 6, wherein the fifth transistor operates in a saturation region in the emission period.

8. The pixel of claim 6, wherein a voltage level of the data voltage is variable, and a length of the emission period is constant.

9. The pixel of claim 6, wherein a voltage level of the data voltage is constant, and a length of the emission period is variable.

10. The pixel of claim 2, wherein each of the first transistor, the second transistor, the third transistor, the fourth transistor, and the fifth transistor is a p-type metal oxide semiconductor transistor.

11. The pixel of claim 10, wherein a body of each of the first transistor, the second transistor, the third transistor, the fourth transistor, and the fifth transistor receives the high power voltage.

12. The pixel of claim 1, further comprising:
a first capacitor including a first terminal connected to the first node and a second terminal which receives the high power voltage.

13. A display device comprising:
a display panel including a pixel; and
a panel driver which provides a data voltage, a first gate signal, and an emission signal to the pixel,
wherein the pixel comprises:
a light-emitting element including an anode and a cathode which receives a low power voltage;
a first transistor including a gate connected a first node, a first terminal connected to a second node, and a second terminal connected to a third node;
a second transistor which transmits the data voltage to the first node in response to the first gate signal;
a third transistor including a gate connected to the second node, a first terminal which receives a high power voltage, and a second terminal connected to the second node; and
a fifth transistor including a gate which receives the emission signal, a first terminal connected to the third node, and a second terminal connected to the anode of the light-emitting element, and
wherein an activation level of the emission signal is higher than an activation level of the first gate signal.

14. The display device of claim 13, wherein the pixel further comprises:
a fourth transistor which transmits an initialization voltage to the anode of the light-emitting element in response to a second gate signal.

15. The display device of claim 14, wherein an activation level of the second gate signal is lower than the activation level of the first gate signal.

16. The display device of claim 15, wherein a voltage level of the initialization voltage is lower than a voltage level of the low power voltage.

17. The display device of claim 14, wherein, in an initialization and writing period of a frame, each of the first gate signal and the second gate signal has the activation level, and the emission signal has a deactivation level.

18. The display device of claim 17, wherein, in an emission period of the frame after the initialization and writing period, the emission signal has the activation level, and each of the first gate signal and the second gate signal has a deactivation level.

19. The display device of claim 18, wherein the fifth transistor operates in a saturation region in the emission period.

20. An electronic apparatus comprising:
a processor which generates image data; and
a display device which displays an image corresponding to the image data, wherein the display device comprises:
a display panel including a pixel; and
a panel driver which provides a data voltage, a first gate signal, and an emission signal to the pixel,
wherein the pixel comprises:
a light-emitting element including an anode and a cathode which receives a low power voltage;
a first transistor including a gate connected a first node, a first terminal connected to a second node, and a second terminal connected to a third node;
a second transistor which transmits the data voltage to the first node in response to the first gate signal;
a third transistor including a gate connected to the second node, a first terminal which receives a high power voltage, and a second terminal connected to the second node; and
a fifth transistor including a gate which receives the emission signal, a first terminal connected to the third node, and a second terminal connected to the anode of the light-emitting element, and
wherein an activation level of the emission signal is higher than an activation level of the first gate signal.
